(19) United States
(12) Patent Application Publication
(10) Pub. No.: US 2003/0027537 A1
(43) Pub. Date: Feb. 6, 2003

(54) Providing automatic gain control stability

(76) Inventor: Koji Kimura, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/920,782

(22) Filed: Aug. 1, 2001

(51) Int. Cl. H04B 1/06

(52) U.S. Cl. 455/232.1; 455/234.1; 455/240.1

(57) ABSTRACT

A system and method for receiver automatic gain control (AGC) adapted to provide a feedback signal having improved stability is described herein. The system and method includes taking plurality of samples of received signal, calculating power for each of the plurality of samples of the received signal, and computing an average value of the calculated powers. An appropriate feedback signal based on the computed average value may then be generated.

### BACKGROUND

The present invention relates to an automatic gain control system, and more particularly, to providing stability in such an automatic gain control system.

Automatic gain control (AGC) typically involves performing analog-to-digital conversion of a received signal, calculating the power of the received signal, and creating a feedback signal to control the gain of an automatic gain control (AGC) component. Moreover, the feedback signal may pass through a pulse density modulator (PDM) and a low pass filter (LPF) to perform digital-to-analog conversion before being provided to the AGC component. The voltage of the feedback signal is used as the control voltage of the AGC component, which controls the gain.

However, due to the power distribution of the received signal, the AGC component may experience instability in the feedback loop. Specifically, spikes in the power sample of the received signal may cause feedback signal to be driven unstable.

### SUMMARY

A system and method for receiver automatic gain control (AGC) adapted to provide a feedback signal having improved stability is described herein. According to one aspect of the present invention, a method for automatic gain control is disclosed. The method includes taking plurality of samples of received signal, calculating power for each of the plurality of samples of the received signal, and computing an average value of the calculated powers. An appropriate feedback signal based on the computed average value may then be generated.

In another aspect, an automatic gain control system having a sampling element, a power calculator, an averaging element, and a feedback signal generator is disclosed. The sampling element takes multiple samples of received signal. The power calculator is arranged to compute power of each of the multiple samples. The averaging element produces an output that reduces the impact of samples with power level substantially higher than an average power in generation of a feedback gain control signal. The feedback signal generator then generates the feedback gain control signal based on the averaging element output.

In a further aspect, a telecommunication device is described. The device includes an antenna to receive and transmit RF signal, a transmitter, and a receiver. The receiver includes an RF downconverter, an automatic gain control element, an IF mixer, an analog-to-digital converter (ADC), and an automatic gain control system. The RF downconverter downconverts the RF signal to an IF signal. The automatic gain control element controls gain of the receiver by controlling gain of the IF signal. The IF mixer downconverts the IF signal to baseband signal. The ADC converts the analog baseband signal to digital signal. The automatic gain control system provides a feedback gain control signal to the automatic gain control element based on power levels of the digital signal. The automatic gain control system generates the feedback gain control signal by taking multiple samples of the digital signal and averaging the power levels of the multiple samples.

### BRIEF DESCRIPTION OF THE DRAWINGS

FIG. 1 is a block diagram illustrating a conventional AGC system.

FIG. 2A illustrates an example of signal power for a plurality of samples taken in a conventional AGC system.

FIG. 2B shows a power distribution curve of the conventional AGC system in the normalized domain.

FIG. 3 illustrates an example accumulator output that is generated by sampling the received signal power of FIG. 2A.

FIG. 4 is a block diagram illustrating a telecommunications system that utilizes an AGC system according to an embodiment of the present invention.

FIG. 5 is a block diagram of an AGC system in accordance with an embodiment of the present invention.

FIG. 6 is a graph illustrating the power distribution of the AGC system using two samples.

FIG. 7 is a graph illustrating the power distribution of the AGC system using four samples.

FIG. 8 is a graph illustrating the power distribution of the AGC system using eight samples.

FIG. 9 is a graph illustrating the power distribution of the AGC system using sixteen samples.

FIG. 10 is a flowchart of an automatic gain control technique according to an embodiment of the present invention.

### DETAILED DESCRIPTION

In recognition of the above-stated difficulties with prior automatic gain control (AGC) techniques, the present invention describes embodiments for converging the power distribution curve used in the feedback signal to Gaussian distribution. Convergence of power curve to Gaussian distribution provides stability to the feedback loop. Consequently for purposes of illustration and not for purposes of limitation, the exemplary embodiments of the invention are described in a manner consistent with such use, though clearly the invention is not so limited.

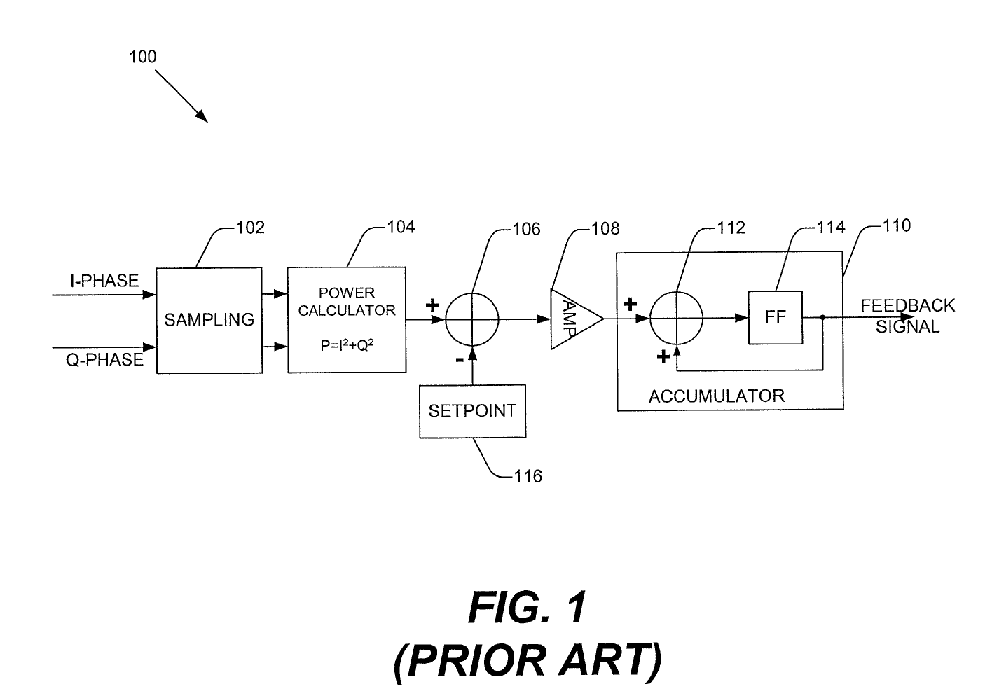

A block diagram of a conventional AGC system is illustrated in FIG. 1. In the diagram, a sampling element 102 samples in-phase and quadrature-phase outputs of analog-to-digital (A/D) converters at a rate that is sufficient to perform automatic gain control. A power calculator 104 then calculates the power of the received signal. The power is calculated as the sum of the square of the in-phase and quadrature-phase components. An adder 106 calculates the difference between the calculated power and a setpoint 116. The setpoint 116 provides a pre-programmed value of the output power having a desired gain. This difference provides a base for the feedback signal.

An amplifier 108 determines the loop gain by controlling the polarity of the feedback signal based on the difference signal received from the adder 106. The amplifier 108 may also determine the speed of the convergence. An accumulator 110 then generates the feedback signal that is provided to the AGC component (not shown). The accumulator 110 may include an adder 112 and a flip-flop 114. The flip-flop 114 holds the value of the feedback signal until the next iteration.

In the AGC technique, if the received signal power increases, the power of the samples may become greater than the setpoint 116. This results in the accumulator value increasing, which decreases the gain of the AGC component. The decrease in the gain, in turn, decreases the power of the received signal. Therefore, if the received signal power decreases, the sample power may become less than the setpoint 116. Thus, this decreases the accumulator output and increases the feedback gain, which again increases the received signal power. Accordingly, this technique may provide effective gain control.

Generally, the value of the accumulator in the AGC system increases or decreases gradually. However, the above-described technique may sometimes generate an unstable feedback signal due to the shape and distribution of the received signal power. There may be instances when the power of the samples jumps instantaneously creating power spikes.

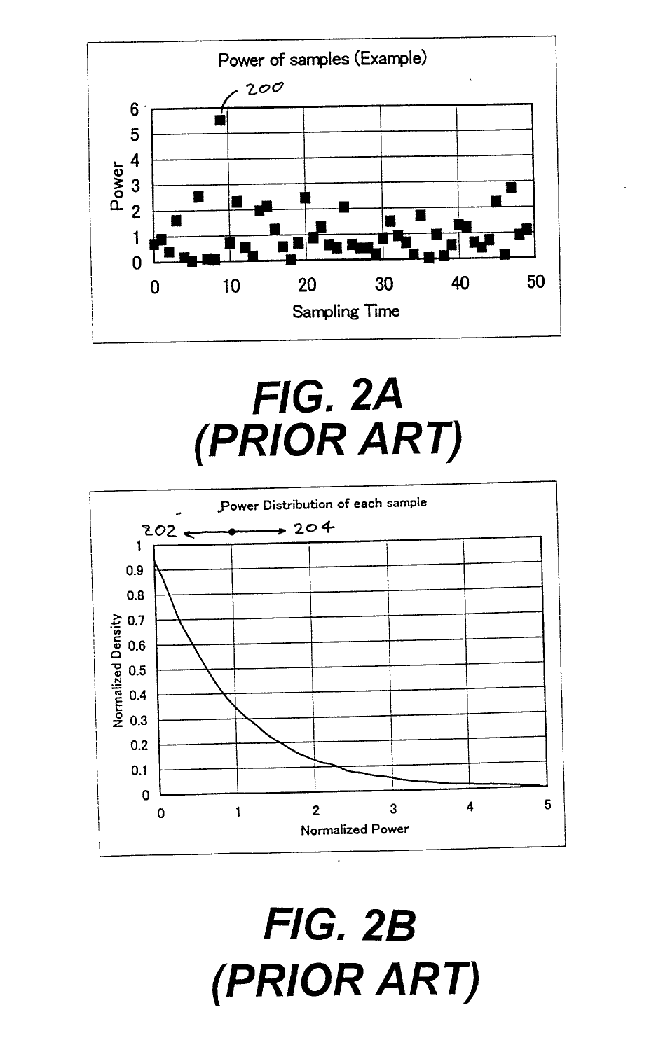

FIG. 2A illustrates an example of signal power for a plurality of samples with respect to time. The figure shows a sample 200 with substantially higher power level than other samples. This jump in power results in a corresponding jump in the value of the accumulator.

FIG. 2B shows the power distribution curve in the normalized domain, where x-axis is normalized by the average power. Thus, a value of 1 represents an average power. The figure shows a skewed distribution where the power below the average (i.e. less than 1) 202 has substantially more density than the power above the average (i.e. greater than 1) 204. Accordingly, the power above the average 204 has substantially less density but has larger offset from the average due to the above-described power spikes.

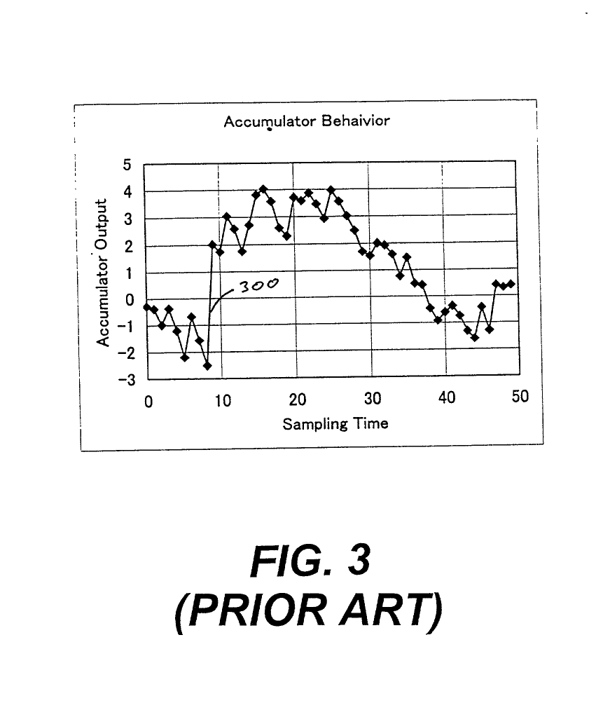

An example accumulator output that is generated by sampling the received signal power of FIG. 2A is illustrated in FIG. 3. It can be seen that a jump 200 in the signal power results in a corresponding jump 300 in an accumulator output. Since the accumulator output determines the gain of the feedback signal, a large jump 300 in the value of the accumulator output may result in an unstable feedback signal. This may cause an increase in the number of bit errors, which may further result in decoder errors.

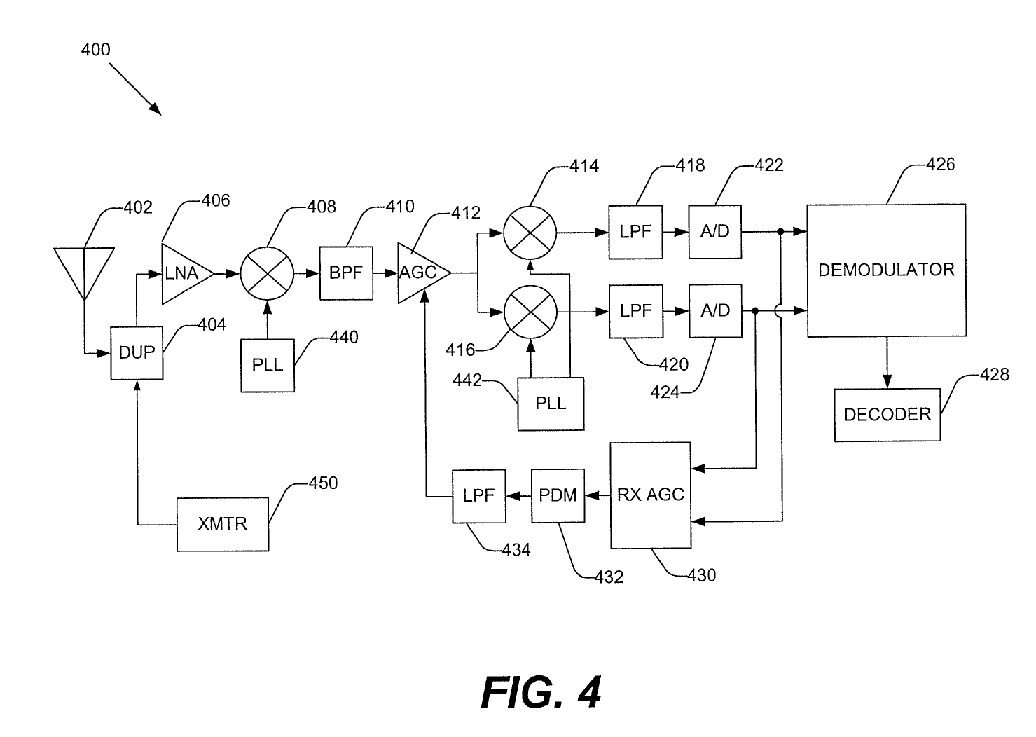

FIG. 4 is a block diagram illustrating a telecommunications device 400, such as a mobile station, that utilizes an AGC system according to an embodiment of the present invention. In the illustrated embodiment, an antenna 402 in the mobile station may receive a signal transmitted by a base station. The received signal is separated from the transmission side 450 by a duplexer 404, and is amplified by a low noise amplifier (LNA) 406. The received signal is then down-converted from a radio frequency signal to an intermediate frequency signal by an RF mixer 408. The local oscillator function may be provided by a phase-lock loop 440. A band pass filter 410 removes the high frequency component of the received signal. The AGC component 412 then adjusts the strength of the received signal based on the feedback signal received from the receiver AGC system 430.

The received signal is down-converted to base band by IF mixers 414, 416. Another phase-lock loop 442 may provide the local oscillation function for the IF down conversion. The first IF mixer 414 generates an in-phase signal, and the second IF mixer 416 generates a quadrature-phase signal. Low pass filters (LPF) 418, 420 remove unnecessary high frequency components. Analog-to-digital (A/D) converters 422, 424 convert the in-phase and quadrature-phase signals from analog to digital. The signals then pass through a demodulator 426 and a decoder 428, which reconstruct the data stream from the received signal.

The in-phase and quadrature-phase output signals of the A/D converters 422, 424 are also received by a receiver AGC system 430. However, the AGC system 430 may require a sampling rate that is lower than the sampling rate of the demodulator 426. Accordingly, the AGC system 430 may not have to use all of the samples from the A/D converters 422, 424.

The AGC system 430 calculates the signal power received from the A/D converters 422, 424. Moreover, the AGC system 430 generates a feedback signal that is provided to a pulse density modulator (PDM) 432 and a low pass filter 434. The modulator 432 and the filter 432, in combination, perform digital-to-analog conversion. The feedback signal may then be provided to the AGC component 412 to control the gain of the telecommunications device 400.

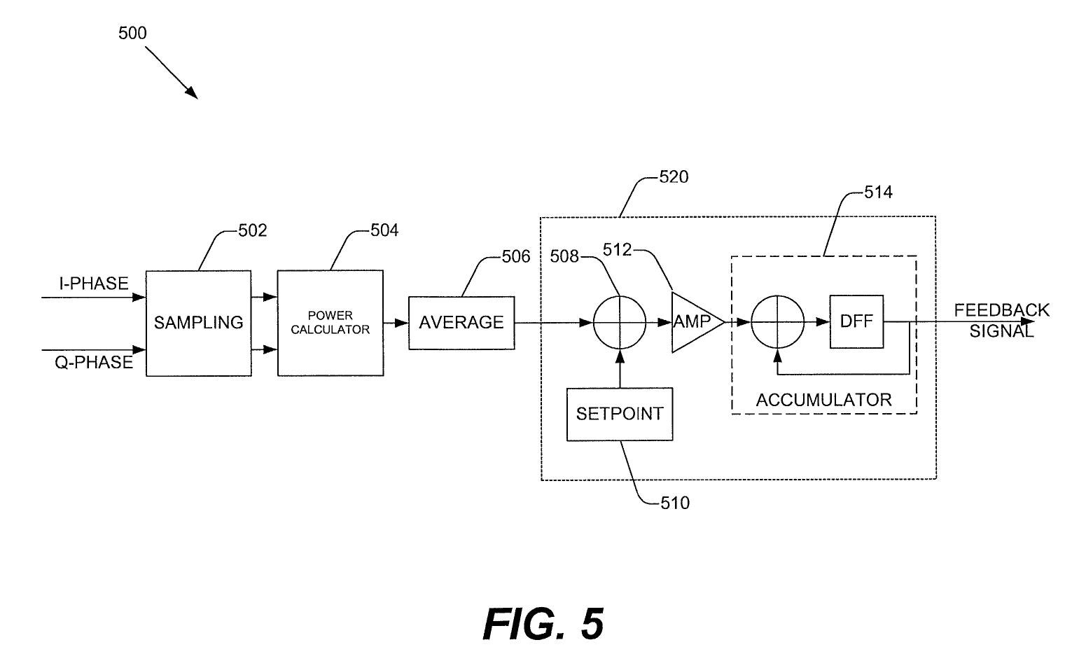

A block diagram of an AGC system 500 in accordance with an embodiment of the present invention is illustrated in FIG. 5. In one embodiment, the function of this system 500 is substantially similar to that of the AGC system 430 in FIG. 4. In the illustrated embodiment, a sampling element 502 samples the in-phase and quadrature-phase outputs of the A/D converters 422, 424. However, the sampling element 502 of the present system 500 differs from the sampling element 102 of the conventional AGC system 100 in that the sampling element 502 of the present system 500 samples multiple signals received from the A/D converters 422, 424 before calculating the power in the power calculator 504. Furthermore, an averaging element 506 averages the power of the multiple samples taken by the sampling element 502. Thus, the averaging element 506, in conjunction with sampling element 502 that takes multiple samples, operates to reduce the impact of power spikes.

The averaging element 506 may be implemented with any element that reduces the impact of power spikes in the shape of the power distribution curve. Thus, in an alternative embodiment, the averaging element 506 may be implemented as a selector that eliminates any samples above a threshold value, such as three time the standard deviation of the samples, so that occasional power spikes may be eliminated from the feedback signal generation process.

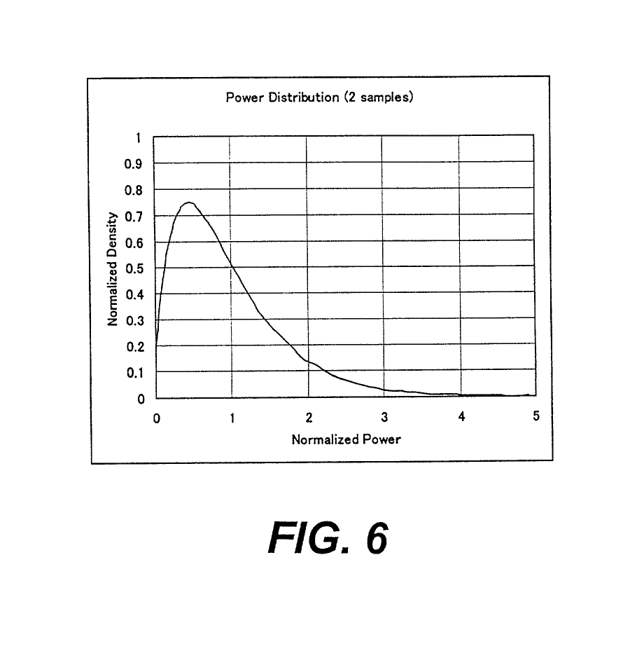

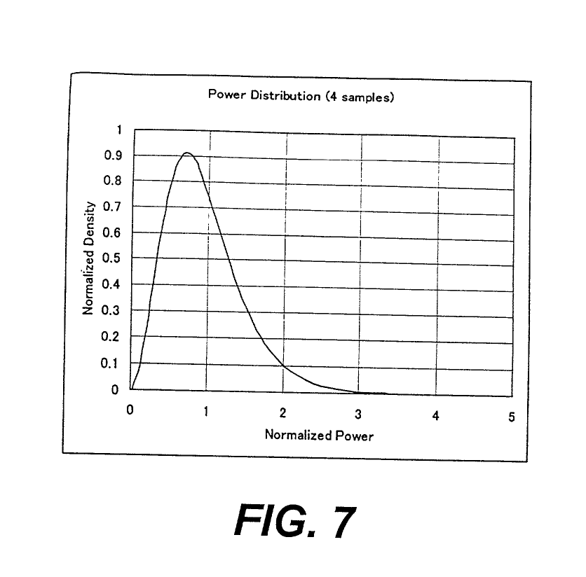

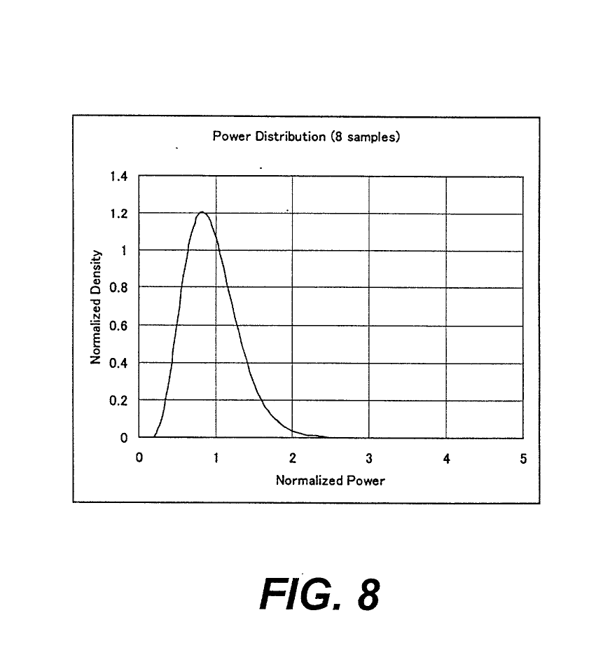

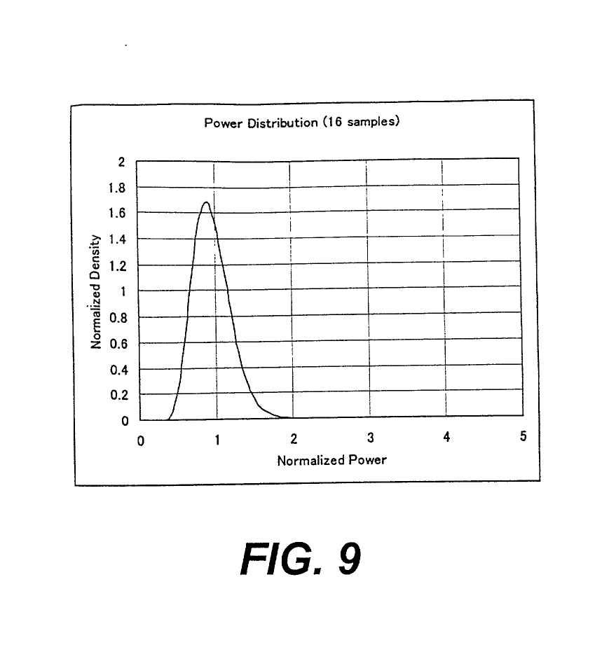

FIGS. 6 through 9 show the impact of sampling and averaging multiple samples on the power distribution and, in turn, on the stability of the present AGC system 500. FIG. 6 uses two samples; FIG. 7 uses four samples; FIG. 8 uses eight samples; and FIG. 9 uses sixteen samples. In the illustrated embodiments, increasing the number of samples taken by the sampling element 502 gradually converges the initial power distribution curve of FIG. 2B (conventional system using one sample) to Gaussian distribution. Thus, as the number of samples increases, the peak of the power distribution approaches the average power (i.e. 1 on x-axis). Therefore, the power distributions of the present embodiments produce equal probability that the sample (i.e. multiple sample) may fall above or below the average power. Furthermore, the offset of the samples from the average gradually decreases to provide stability to the feedback signal of the AGC system 500.

The remaining blocks in the AGC system 500 of the present invention is same as that of the conventional system 100. These blocks are illustrated as a feedback signal generator 520. The generator 520 includes an adder 508 that calculates the difference between the calculated power and a setpoint 510. This difference provides the base of the feedback signal. The generator 520 also includes an amplifier 512 which determines the loop gain by controlling the polarity of the feedback signal and the speed of the convergence. An accumulator 514 generates the feedback signal that is provided to the AGC component (not shown).

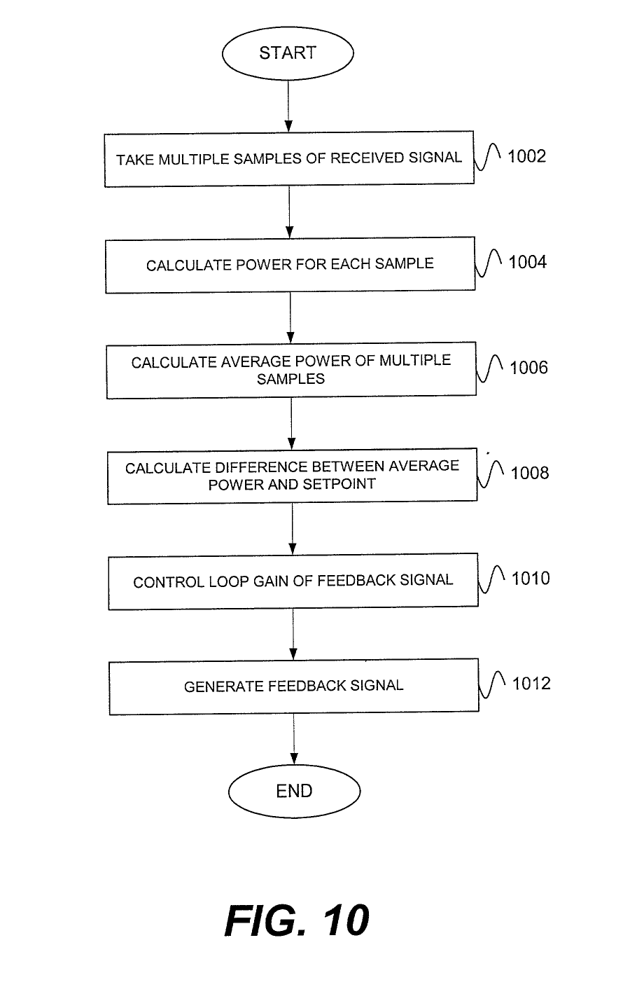

FIG. 10 is a flowchart of an automatic gain control technique according to an embodiment of the present invention. The technique includes taking multiple samples of the received signal, at 1002. The received signal may be divided into an in-phase component and a quadrature-phase component. The power of the sample is then calculated at 1004. The power may be calculated by adding the square of the in-phase component and the square of the quadrature-phase component of the received signal.

An average of the calculated powers for the multiple samples is computed at 1006. The number of samples may be any number greater than one. However, the actual number of sample to be taken should be based on the desired stability and the complexity of the required calculation. The greater the number of samples, the greater the stability of the feedback signal generated by the AGC system 500. However, increasing the number of samples also increases the complexity of the calculation required to determine the average power of the received signal. Four or eight samples may work well, whereas sixteen samples may require too complex a calculation to justify the relatively small increase in feedback signal stability.

A difference between the average power of the sample and a setpoint is calculated, at 1008. In one embodiment, the setpoint may be pre-programmed. In another embodiment, the setpoint may be determined empirically by trying different values to determine which one provides the greatest feedback stability. Thus, the loop gain of the feedback signal is then controlled, at 1010, by controlling the polarity and the speed of convergence of the feedback signal. The feedback signal is generated, at 1012, and provided to the AGC component.

There has been disclosed herein embodiments for converging the power distribution curve used in the feedback signal to Gaussian distribution. Convergence of power curve to Gaussian distribution provides stability to the feedback loop.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the number of samples to be taken and averaged have been illustrated as being between 2 and 16, the actual number of sample should be based on the trade-off between the stability and the calculation complexity. In general, more calculation complexity requires more power consumption. In other instances, well-known structures and functions were not described in elaborate detail in order to avoid obscuring the subject matter of the present invention. Accordingly, the scope and spirit of the invention should be judged in terms of the claims which follow.

What is claimed is:

1. A method for automatic gain control, comprising:
taking a plurality of samples of received signal;
calculating power for each of said plurality of samples of the received signal;
computing an average value of said calculated powers for said plurality of samples; and
generating an appropriate feedback signal based on said computed average value.

2. The method of claim 1, wherein said computing an average value includes selectively eliminating any sample above a pre-specified threshold value.

3. The method of claim 2, wherein said pre-specified threshold value includes a value that is three time a standard deviation of samples of the received signal.

4. The method of claim 1, wherein said taking a plurality of samples of received signal includes:
receiving an in-phase component and a quadrature-phase component of the received signal; and
sampling the in-phase component and the quadrature-phase component of the received signal.

5. The method of claim 4, wherein calculating the power for each of said plurality of samples includes:
first calculating a square of the sampled in-phase component;
second calculating a square of the sampled quadrature-phase component; and
third calculating a sum of the square of the sampled in-phase component and the square of the sampled quadrature-phase component.

6. The method of claim 1, wherein said generating includes differencing said average value and a pre-specified setpoint.

7. The method of claim 6, further comprising: controlling the loop gain of a feedback signal.

8. An automatic gain control system, comprising:
a sampling element to take multiple samples of received signal;
a power calculator arranged to compute power of each of said multiple samples;
an averaging element arranged to produce an output that reduces the impact of samples with power level substantially higher than an average power in generation of a feedback gain control signal; and
a feedback signal generator to generate the feedback gain control signal based on said output of said averaging element.

9. The system of claim 8, wherein said output of said averaging element is an average value of said multiple samples.

10. The system of claim 8, wherein said output of said averaging element is a value that is an average of said multiple samples after selectively eliminating samples that are greater than three time the standard deviation of samples in the received signal.

11. The system of claim 8, wherein said feedback signal generator includes an adder to determine the difference between the output of said averaging element and a pre-specified setpoint.

12. The system of claim 11, further comprising an amplifier to control a loop gain.

13. The system of claim 12, further comprising an accumulator to generate the feedback gain control signal.

14. A system, comprising:
an automatic gain control component; and
an automatic gain control system to provide functions which enable the system to:
take a plurality of samples of received signal,
calculate power for each of said plurality of samples of the received signal,
compute an average value of said calculated powers for said plurality of samples, and
generate and send an appropriate feedback gain control signal to the automatic gain control component, based on said computed average value.

15. A telecommunication device, comprising:
an antenna to receive and transmit RF signal;
a transmitter; and
a receiver including:
an RF downconverter to downconvert the RF signal to an IF signal,
an automatic gain control element to control gain of the receiver by controlling gain of the IF signal,
an IF mixer to downconvert the IF signal to baseband signal,
an analog-to-digital converter (ADC) to convert the analog baseband signal to digital signal, and
an automatic gain control system providing a feedback gain control signal to the automatic gain control element based on power levels of said digital signal, said automatic gain control system operating to take multiple samples of said digital signal and averaging the power levels of said multiple samples to produce said feedback gain control signal.

16. The device of claim 15, wherein said automatic gain control system of said receiver includes a sampling element to take multiple samples.

17. The device of claim 16, further comprising an averaging element arranged to produce an output that reduces the impact of samples with power level substantially higher than an average power in generation of said feedback gain control signal.

18. The device of claim 17, wherein said output of said averaging element is an average value of said multiple samples.

19. The device of claim 17, wherein said output of said averaging element is a value that is an average of said multiple samples after selectively eliminating samples that are greater than three time the standard deviation of samples in the digital signal.
